(19) United States
(12) Patent Application Publication
(10) Pub. No.: US 2020/0269781 A1
(43) Pub. Date: Aug. 27, 2020

(54) CONTROL UNIT AND CONTROL SYSTEM FOR A COMBINATION FORMED BY A VEHICLE AND AN ATTACHMENT DEVICE

(71) Applicant: SYN TRAC GmbH, Bad Goisem (AT)

(72) Inventor: Stefan Putz, Bad Goisern (AT)

(21) Appl. No.: 16/870,652

(22) Filed: May 8, 2020

Related U.S. Application Data
(63) Continuation of application No. PCT/EP2018/080984, filed on Nov. 12, 2018.

(30) Foreign Application Priority Data
Nov. 10, 2017 (DE) 102017126502.3
May 16, 2018 (DE) 102018111767.1

(51) Int. Cl. B60R 16/023; G06F 13/42; G05B 19/4155

(52) U.S. Cl. CPC B60R 16/0231; G06F 13/42; G06F 2213/40; G05B 2219/2637; G05B 19/4155

(57) ABSTRACT

The disclosure relates to a digital control unit as well as a control system for a combination of a vehicle and at least one attachment coupled from a vehicle. The vehicle includes a digital vehicle control unit and the attachment a digital attachment control unit. The control units each have a control program unit with a local allocation module, which controls components in line with activation notifications of an operating element. A central allocation module generates an allocation notification upon a new allocation of an operating element to a component, which is sent at least to the local allocation module connected with this component.

### CROSS-REFERENCE TO RELATED APPLICATIONS

This application is a Continuation of and claims the benefit of priority under 35 USC 120 to PCT/EP2018/080984 filed Nov. 12, 2018, which claims priority to DE 10 2017 126 502.3 filed Nov. 10, 2017, and DE 10 2018 111 767.1 filed May 16, 2018, the entire contents of each are hereby incorporated by reference.

The present disclosure relates to a control unit and a control system for a combination of a vehicle and at least one attachment coupled to the vehicle.

Utility vehicles carry out a large spectrum of tasks in agricultural and communal facilities. These tasks can for example comprise snow ploughing, grass cutting, harvesting, fertilising, ploughing or tree felling. A utility vehicle typically pulls or pushes an attachment, which was constructed for the intended task. As there is a large number of tasks, correspondingly many attachments have been developed, which sometimes also differ depending on individual manufacturers. Not every utility vehicle can therefore control and operate every attachment.

More and more attachments appear on the market, which are ever more intelligent and/or specialised than their predecessor versions. Until now this diversity was dealt with by constantly adapting the tractor. The cockpit of the driver can therefore be crowded with a number of monitoring screens and operating elements. A separate operating element may be provided for every attachment. During a rapid changeover of the attachments in particular the driver may also omit to detect the operating elements of a specific attachment and install the new operating element. This makes the cockpit very chaotic.

As utility vehicles are very expensive one will attempt to operate these for as long as possible. Working lives of 20 years or more are therefore no rarity. During this time it must also be ensured that each new attachment acquired for the utility vehicle is also compatible with the same. System control between the utility vehicle and the attachment in particular can cause substantial problems. These problems were recognised very early.

The consistent agricultural BUS system (LBS®) was developed first. The Isobus® system is considered to be its successor. The Isobus® fulfils the basic task of standardising different interfaces between the utility vehicle and an attachment. This includes plugs, lines and also data formats and interfaces.

The Isobus® has however not established itself as a consistent standard because a plurality of specifications, sometimes company specific, exist. A utility vehicle equipped with Isobus® can for example have a UT (Engl.: Universal Terminal) and a job computer (TECU), although it does not necessarily comprise all the other components. Then there are also company specific standards. To retrofit and/or install all components after every introduction of a new system and/or standard in the utility vehicle is not only costly, and thus uneconomical, the great number of systems also makes this almost impossible.

DE 10 2011 006 052 A1 discloses a control system for a combination of an agricultural tractor and an agricultural, tractor-coupled device. The control system comprises a tractor control unit and an device control unit. The tractor control unit serves for regulating the speed of the tractor. The device control unit controls the functions of the device, but is also coupled to the tractor control unit in such a way that the device speed requirements are sent to the tractor control unit.

EP 1 277 388 A1 discloses a control system of an agricultural device, wherein a multitude of sensors connected with this agricultural device can influence the operation of the device. Sensors can for example determine the soil consistency for harvesting machines and the entire agricultural device can react to this in that its performance is adapted.

### SUMMARY OF THE DISCLOSED SUBJECT MATTER

The disclosure is based on the task of providing a digital control unit and a control system for a combination of a vehicle and at least one attachment coupled to the vehicle, which allow a flexible coupling of different attachments to a vehicle.

A further task of the present disclosure is the provision of a digital control unit and a control system for a combination of a vehicle and at least one attachment coupled with the vehicle, which allow simple development and maintenance. A digital control unit according to the disclosure has a central processor unit for controlling at least one component of a vehicle or an attachment and is equipped with a control program unit, which is merely stored on the control unit and can be implemented there. A component is a part of a vehicle or an attachment that can be controlled electrically, electronically, mechanically or hydraulically. Other control possibilities, such as for example compressed air, are also possible. A component can for example be a motor, a nozzle or a sensor. Controlling comprises the activation, switching off, regulating and reading of the components. Other control possibilities, such as for example interrupting or signalling, are also possible.

The digital control unit has an interface to a data bus, by means of which several operating elements can be coupled to the control unit, and this control unit coupled with one or more further control units. When the operating elements are activated an activation notification is generated and transmitted via the data bus, wherein the activation notification includes at least information about the type of activation and about the operating element that have generated this activation notification. The control program unit has a local allocation module, which reads the activation notifications for a specific component that is coupled to the digital vehicle control unit from the data bus, and transmits corresponding control signals to this component. The control program unit has a central allocation module that generates a notification to the local allocation module of this or a further control unit when an operating element is newly allocated to a component, and sends this to the respective allocation unit via the data bus, so that it will store this allocation of the operating element to the components in such a way that all activation notifications transmitted via the data bus are forwarded from the respective operating element to this component to control the same accordingly.

This digital control unit can therefore be provided on a vehicle and/or an attachment, which can be coupled with each other, wherein operating elements can in principle be randomly allocated to a component of the vehicle or the attachment by means of the local allocation module and the at least one central allocation module. Any attachments can be combined with a vehicle in this way, whilst a simple operation of the attachments is nevertheless ensured. This therefore allows a flexible combination of attachments and vehicles.

In principle it is also possible that several vehicles can be coupled with each other or also that several attachments can also be coupled with each other on one vehicle. It is also possible to couple several attachments with each other and to couple this group of attachments to a vehicle. As vehicles and attachments can be freely coupled with other, both are hereafter together described as functional devices. A functional device equipped with such a digital control unit can therefore be coupled with another functional device that also has a digital control unit as desired. Such a digital control unit has at least one central allocation module.

The local allocation module can be connected with one or more components of the respective functional device on which it is arranged. The local allocation module controls these components in such a way that it reads the activation notifications for a specific component from the data bus and forwards corresponding control signals to this component. These control signals can be the activation devices themselves, which are then simply passed on. It is however also possible that the local allocation modules are designed in such a way that they convert the activation notifications into control signals that are suitable for the respective component. These control signals can be analogue and/or digital control signals.

The allocation of the respective operating element to the respective component is stored on the local allocation module. When this allocation is changed the central allocation module generates an allocation notification, which is transmitted at least to the local allocation module, with which the corresponding component is controlled to change the allocation. A new allocation can be triggered manually by an operator on an operating element. A new allocation can however also be generated in that a specific attachment is for example coupled to a vehicle or to a further attachment, wherein the coupling automatically triggers a new allocation or one or more operating elements to the corresponding component of the attachment.

According to a further aspect of the present disclosure a control system for a combination of a vehicle and at least one attachment coupled with the vehicle is provided. The control system comprises the following:

a digital vehicle control unit with a central processor unit for controlling at least one component of the vehicle,

a digital attachable control unit with a central processor unit for controlling at least one component of the attachment,

a disconnectable data connection between the vehicle control unit and the attachable control unit, wherein the disconnectable data connection comprises a data bus,

operating elements, which are connected with the vehicle control unit as well as with the attachable control unit via the data connection, wherein a confirmation notification is generated upon activation of the respective operating element and is transmitted via the data bus, which includes at least one information about the type of activation and about the operating element.

Each control unit has a control program unit, which is stored only on the respective control unit and can be executed there. The control program units are each equipped with an interface for communicating via the data bus, so that all control program units can exchange data. The control program units of the respective control units of the vehicle and the attachments are designed completely independently from each other. They can however communicate with each other via the data connection. For this it is possible to develop and maintain the control program units completely independently from each other. Despite this it is possible that components connected with another control unit can be controlled with operating elements connected with a control unit in that the corresponding activation notifications are transmitted from one control unit to another control unit via the data connection.

The entire control system appears as one consistent control system to a user, with which he can control the vehicle and all attachments. Only the communication between individual control units is standardised. The structure of the activation notifications is thus for example fixed. Individual control program units can be developed and maintained independently from each other in this way. It requires only a common data technical interface for communicating via the data bus. Such a vehicle control unit and/or at least one of the attachable control units are preferably equipped with a central allocation module. Each control program unit can have an output program module for issuing information that reflects the condition of the control program unit and/or of components coupled to the same, wherein the output program module generates control commands, with which this information can be issued directly at an output element.

An output element is for example a monitor, a loudspeaker, a lighting means such as for example a light diode. The control commands generated by the output program module can be directly implemented by the output element without requiring further conversion or processing of the control commands. An output program module of a control unit of a functional device can generate control commands in this way, which are transmitted to an output element of a control unit of another functional device via the data connection and are issued there, without this other control unit needing to further process these control commands. It only needs to forward these control commands to the output elements. In this way it is possible to couple any functional devices with each other without providing corresponding program units designed specifically for the respective functional devices coupled to it on a central functional device. Instead the coupled functional devices themselves provide the necessary program units for enabling a corresponding output. The output can be an image or a sound signal.

The vehicle can have a coupling for coupling attachments, which has a drive shaft and/or a plug-in connector for at least one electric line and/or a plug-in connection for a hydraulic line and/or a plug-in connection for a pneumatic line. The control program units of the vehicle and the attachments are designed in such a way that they can influence the operation of the vehicle and/or attachment coupled with the same simply through instructions, requests, commands, with which the mechanical, electrical, hydraulic or pneumatic capacity of a coupling is defined. The term “capacity” does not mean the physical capacity here, but a capacity in a figurative sense, so that the effect of the coupling components in the area of the coupling is clearly defined in this way. The hydraulic or pneumatic capacity can for example be defined as a pressure value or pressure range. The electric capacity can be defined as a current value, a voltage value or also as an electrical capacity. The mechanical capacity can for example be defined as a torque, speed or mechanical capacity in a narrower sense. These instructions, requests and commands can each include an upper and/or lower limit of the requested, desired capacity or an exact value of the capacity. The capacity delivered at the coupling can therefore be agreed between the control units with these instructions, requests and commands without the respective control unit having exact knowledge of the function and construction of the respective other functional device.

The vehicle control unit and/or one of the other control units preferably automatically recognises whether a new attachable control unit has been coupled. This can for example be realised with the regular transmission of identification telegrams by the respective control unit to all devices connected to the data bus. The time interval between two identification telegrams is greater than 10 ms, preferably greater than 1 s, and in particular greater than 3 s. The time distance between two successive identification telegrams should not be greater than 10 s and preferably not greater than 5 s. Identification telegrams are preferably standardised notifications that are understood by each attachment without prior communication or another connection construction having taken place between the respective devices.

Alternatively it can be checked by regularly reading an attachment sensor whether a new attachment has been connected. The attachment sensor can also actively send a signal to the vehicle control unit. The attachment sensor is for example a wire with a connection piece on the coupling. If an attachment is connected the wire is short-circuited. The short circuit is then detected by a vehicle control unit. Other sensors, such as for example pressure or approximation sensors, with which the coupling can be registered, are also possible.

A newly coupled attachable control unit is preferably automatically integrated into the system for data transmission. Corresponding addresses are for example allocated automatically here and/or the control units automatically adapt to each other via a master/slave allocation.

Initial notifications to the vehicle control unit are preferably sent after coupling the attachable control unit. Initial notifications can however also be sent to the attachable control unit by the vehicle control unit. These initial notifications can include information that is necessary for the initial connection. This can for example include blocking commands that prohibit the user from operating certain systems, whilst the central allocation module allocates the components and operating elements. The initial notifications can also include specification references for the attachment. In the simplest case the initial notifications can also consist of just a type description or MAC address.

The automatic recognition and integration of the attachment has the advantage that coupling can be carried out very quickly. A user only needs to couple the attachment mechanically to the vehicle. The logic connection is completed automatically. No further settings by the user are required. The central allocation module can generate a notification to the local allocation module during a new allocation of an operating element and send it to the same, the components of which are currently allocated to the operating element, in order to cancel this allocation. This notification can be the allocation notification already explained above, which is then read by this allocation module. It can however also be a separate notification for cancelling the allocation.

After coupling an attachment to a vehicle the control program unit this attachment can send one or more notifications to the central allocation module, in which at least the components of the attachment are defined, so that the central allocation module can register these components. Corresponding notifications of the vehicle can also be sent to the central allocation module. These notifications preferably comprise a component description and/or an interaction description.

The component description comprises information as to which components are available on the respective attachments or vehicles, which mechanical and electronic interfaces to other devices they have, how the components can be activated and/or which information they can send. The interaction description comprises information about the operating and issuing elements with which the respective attachment can be controlled. Optionally they can include addition information that comprises information about necessary interfaces and/or input ranges, such as minimum or maximum values.

The component description and/or the interaction description can include data for a graphic user interface, such as for example pictograms or image illustration of components, parts of the vehicle and/or the attachments. Complete descriptions of a graphic user interface, for example in the form of a mark-up language file (English: mark-up language file) can however also be included in the component description and/or the interaction description. Outputs and inputs can be realised via this graphic user interface, which comply with the requirements of the component description and/or the interaction description. The component description and/or the interaction description are thus taken into consideration during the creation of the graphic user interface. Data can be used for adapting an existing graphic user interface or for creating a completely new graphic user interface. Separate data for generating a graphic user interface can also be transmitted as part of the disclosure. Such a graphic user interface must however take the stipulations of the component description and/or the interaction description into consideration.

All components that can be controlled by the control system are registered by the central allocation module in this way. The corresponding operating and output elements are preferably allocated and the attachment can issue corresponding information to the control program unit. It is not necessary here that the vehicle first holds information from the attachment. This has the advantage that unknown attachments can also be connected with the vehicle. The vehicle, or the output element, does not need to store information about the attachment either. The software of the vehicle therefore does not need to be updated when a further attachment is connected. If a crop protection device is for example connected as an attachment, the plant protection device transmits all necessary information such as for example a pictogram, the number of nozzles, the position of the nozzles, etc. If another crop protection device with a greater number of nozzles is now connected, the information correspondingly also changes, so that this is always up to date. No new information needs to be set in the vehicle.

The operating elements are preferably designed in such a way that only two classes of activation notifications exist, wherein one class includes a logic value (true or false) and the other class a number value that specifies the degree of activation. In this way the activation notifications are unified irrespective of whether the operating element is a steering wheel, a joystick, a touchscreen, a key, a pedal, a selection lever or similar. The conversion of the activation notifications into control signals takes place in the local allocation modules, wherein number values can generate a control signal that is proportional to the transmitted number value, an integral of the number values transmitted over a pre-determined time period, or a deduction (differential) of the transmitted number values. Control signals can of course also be generated by the respective local allocation module, which are a combination of a proportional and/or integral and/or differential signal. It is thus determined at the allocation module how the respective component reacts to the respective activation at the operating element.

The operating elements that generate the activation notifications with a logic value are preferably designed in such a way that different types of activation notifications exist, wherein one type each

switches when pressed,

switches when it is released,

switches until it is released,

switches a one-off signal (latch) when pressed,

switches a one-off signal (latch) when it is released, or

switches a one-off signal (latch) until it is released.

If switching takes place when pressed the button sends an activation notification at regular intervals as soon as the button is pressed and for as long as the switch receives the command not to send anymore. If switching takes place upon release the button sends an activation notification as regular intervals as soon as the button is released once more and for as long as the switch receives the command not so send anymore. If switching takes place until release the button sends an activation notification as regular intervals for as long as the button is pressed. If the button is no longer pressed, the activation notifications will cease. With latch switching one respective brief one-off activation notification only is sent. The exception here is latching until it is released. A brief activation notification is sent when pressing as well as when releasing here. In this way different components can be controlled differently. With a horn signal it may for example be meaningful here that the signal is generated only until the button is released. When headlights are switched on the light should however be generated as soon as the button is pressed, and should then not cease upon release either.

It is therefore easily possible with the consistent activation notifications to replace different operating elements, such as for example a steering wheel, a joystick or a scale with a touchscreen to control a specific component. If the vehicle is for example coupled with an attachment for mowing a side strip of roads, the vehicle can be steered and driven independently by an autopilot, wherein a steering wheel operating element is allocated to the mowing unit component of the attachment, so that the alignment of the mowing unit can be controlled by the user of the vehicle with the steering wheel. However, a joystick component of the vehicle is allocated to the steering mechanism of the vehicle to ensure that the user can intervene in the movement of the vehicle, so that the user can manually change the direction of the vehicle if necessary.

The control system can have at least one plug-in connection with an electric interface for the disconnectable coupling of an operating element, wherein the control program unit has one or more operating interface modules for being able to communicate with an operating element coupled to the same. Providing such an electric interface allows different operating elements to be coupled, which can each communicate with an operating interface module with any local allocation modules. The operating interfaces each generate the activation notifications when the operating element is activated. Output elements can also be coupled to this electric interface. Such an operating element to be coupled can also simultaneously be an output element, as is for example the case with a touchscreen.

The control system can have several allocation modules, wherein the central allocation modules are designed in such a way that they are synchronised. Any change in an allocation is forwarded to the other central allocation modules via the data connection immediately, which read and store this change. The control program unit of the control system, and the local allocation module in particular are preferably constructed in layers. The layers comprise an input layer, a functional layer and an output layer. Program components that read in the data coming in from the data bus, from sensors or suchlike are included in the input layer. The program components of the input layer forward this data to program components of the functional layer, where they are processed. The data is then forwarded to program components of the output layer by the program components of the functional layer, which then forward the data to components or other control units. This data can issued directly to the components as analogue or digital control signals or forwarded as notifications via the data bus.

The functional layer is preferably divided into an allocation layer and a signal layer. The program components with which incoming activation notifications are allocated to a specific component are included in the allocation layer. In this way these activation notifications are forwarded to program components of the signal layer, which generate the corresponding control signals for this component from the activation notifications.

The software can be generated and modified very easily with this layer construction, as it is divided into individual components, which are often of a similar design. The software construction also guarantees the greatest possible independence from hardware components or platforms in this way. If these are replaced or adapted only a relatively small adjustment to the respective layer needs to be carried out. If the bus system is for example replaced, only the input and possibly the output layer needs to be adapted.

A further aspect of the present disclosure relates to an adapter for an attachment for a control system explained above. This adapter can be coupled to the data bus and has a local allocation module for the attachment. Existing attachments can be integrated into the control system with such an adapter. According to a further aspect of the present disclosure a vehicle, in particular a tractor, is provided, which has a digital control unit as explained above. According to a further aspect of the present disclosure an attachment that has a digital control unit as explained above is provided, wherein this digital control unit can be equipped with a central allocation module, but must not necessarily have a central allocation unit.

With the present disclosure only the hardware, an operating system and the data structures necessary for steering the vehicle and for activating the operating elements provided on the vehicle as well an allocation module are controlled on the vehicle control unit. The vehicle itself holds no inbuilt detailed information about attachments such as for example the component and/or interaction descriptions, which are held by the attachments and automatically made available by the attachments following the mechanical coupling to the same.

This information held can preferably include authorisation information, which authorises the held information to carry out specific actions on the vehicle. This information can for example be a certificate file. The authorisation information can prevent that the vehicle is manipulated, damaged or stolen in that a manipulated attachment is connected.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1a schematically, a control system according to the disclosure in a combination of a vehicle and a coupled attachment in a side view,

FIG. 1b a control unit in a block diagram,

FIG. 1c parts of a coupling for a connection point between a vehicle and an attachment in a perspective view,

FIGS. 2a and 2b a schematic construction of the control system, the control elements and the operating elements,

FIG. 3a a schematic construction of the software structure for vehicle operation,

FIG. 3b a schematic construction of the layer construction of the software,

FIG. 4a a schematic diagram showing the visualisation,

FIG. 4b a schematic diagram showing the visualisation of attachments without a control program unit,

FIG. 5a a schematic construction of the internal control structure of the vehicle,

FIG. 5b a schematic diagram of the internal bus structure,

FIG. 5c a further schematic diagram of the internal bus structure,

FIG. 6 a schematic construction of a vehicle data bus,

FIG. 7 a schematic construction of a powertrain data bus,

FIG. 8 a schematic construction of a bus structure between a vehicle control unit and an attachment control unit,

FIG. 9 a schematic construction of an Isobus® linkage,

FIG. 10 a schematic diagram showing the parameter telegrams,

FIG. 11a a schematic diagram showing the mapping,

FIG. 11b a further schematic diagram showing the mapping,

FIG. 12 a schematic diagram showing the telegram operating elements,

FIG. 13 a schematic diagram showing the control of the prop valves,

FIG. 14 a schematic diagram showing the communication between a display and an attachment,

FIG. 15 a schematic diagram showing an alternative communication between a display and an attachment without web browser,

FIG. 16 a schematic illustration of possible combinations of controlling attachments at the connection point with the vehicle control,

FIG. 17 a schematic illustration of possible combinations of controlling attachments via a control program unit on the attachment, and

FIG. 18 a schematic illustration of possible combinations of controlling attachments via control units at the connection point with vehicle control and control of complex attachments via their operating elements, which are connected via additional connections in the vehicle.

### DETAILED DESCRIPTION OF AN EXEMPLARY EMBODIMENT

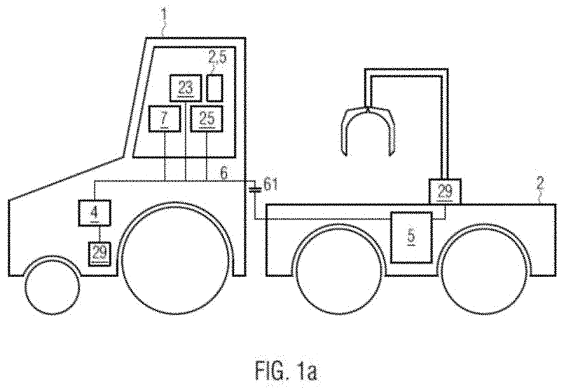

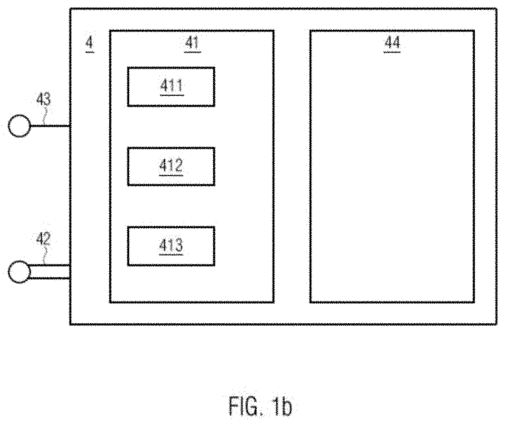

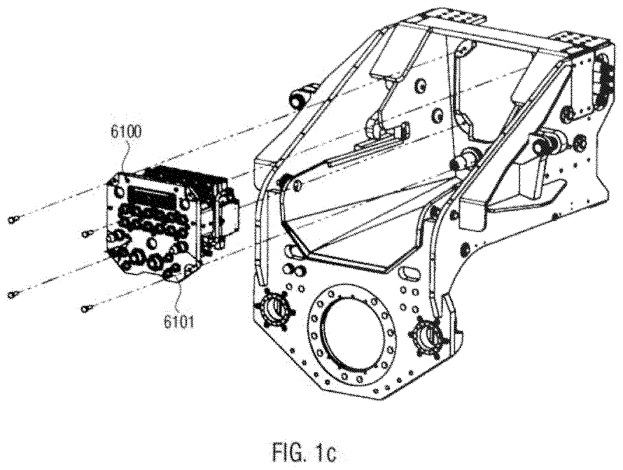

A first embodiment example of a control system 3 according to the disclosure includes a vehicle 1, data buses 6 and an attachment 2 (FIGS. 1a-1c). The vehicle 1 has at least one component 29, a digital control unit 4 for controlling at least one component of the vehicle, operating elements 7 for operating the vehicle and/or attachment components, output elements 23 for illustrating information about the vehicle and/or attachment components and an operator terminal display 25. The attachment 2 has at least one component 29, a digital attachment control unit 5 for controlling at least one component of the attachment. One component 29 can for example be an engine, a controller, a program component for control telegrams for sub-systems 32 or a program component for valves 31.

In principle computer programs are described as modules and devices as elements below. The output element 23 is for example a device for issuing information, whilst an output implementation module 124 is a computer program provided at the output element 23. The vehicle control unit 4 (FIG. 1b) has a processor unit 41, a power supply connection 42, at least one external interface 43 and a memory unit 44, which are switched with each other in a way that is usual and known in itself, i.e. connected with each other signal technically with regard to a data line and energy technically with regard to a power supply in a suitable way. The processor unit 41 has data management units 411, data storage units 412 and data transfer units 413. The attachment control unit 5 is designed like the vehicle control unit 4.

The data busses 6 are formed by two data busses 9, a CAN bus 9a and an Ethernet 9b. The CAN bus 9a is used as a stable bus, primarily for transmitting activation notifications and implementation notifications. The rapid Ethernet 9b connection is primarily used for visualisations. A corresponding plug-in connection is located at the connection point 61 between vehicle and attachment. The operating elements 7 can be a push button, a steering wheel, a joystick, a keyboard, regulator or a touchscreen, amongst other things. The output elements 23 can be a monitor, a text display, a light, a loudspeaker, a siren or a printer, amongst other things. The operator terminal display 25 includes an output implementation module 124 and an operating element module 13 and is substantially a combination of an output element 23 and an operating element 7. The operator terminal display 25 is designed in such a way that such an operating element module 13 comprises a software that can illustrate information received via the Ethernet data bus 9b. In the simplest case this software is a web browser 33. The vehicle 1 and the attachment 2 can be separated and connected at a coupling 61. This coupling 61 has a coupling plate 6100.

The coupling late 6100 is described as follows (FIG. 1c). The coupling plate 6100 is provided for forming electric, electronic, hydraulic and/or pneumatic connections. This coupling plate 6100 comprises an approximately level base plate 6101. This base plate 6101 can be equipped with a plurality of electric, electronic, hydraulic and/or pneumatic as well as mechanical connection elements.

At least two hydraulic connection means 6113 are formed on the base plate 101. These two hydraulic connection means 6113 are provided for activating outrigger plate cylinders fitted on almost all connectable modules. At least one electronic connection means 6102 for providing an electronic connection between a control means of a vehicle and a control means of a vehicle is also provided on the base plate 6101. This electronic connection serves for identifying the type of the module or the trailer or the attachment. At least one electric connection means 6103 is also arranged on the base plate 6101. This electric connection means is provided for activating a light (for example brake, front, rear light, position light or warning light) on the attachment module.

Two electric contacts, control contacts 6104 that are electrically connected through coupling a docking insert with a docking holder in order to detect whether the docking insert is completely pulled into the docking holder and a securing and/or locking means can be activated. Pneumatic connection means 114 are also provided in the base plate 101.

The following connections are simultaneously produced upon connecting two coupling plates according to the disclosure, which are designed for connecting a vehicle with an attachment:
electric connections (lights, electric power supply)
electronic connections (CAN bus 9a, possibly ISOBUS®, Ethernet 9b)
hydraulic connections for vehicle hydraulics and working hydraulics up to six twin-action hydraulic control units with a maximum flow of 100 1 per minute each power-beyond connection with a maximum flow of 180 1 per minute
hydraulic connections for outrigger plates on the attachment
compressed air supply
compressed air brake for additional axle modules and/or trailers or attachments to be coupled.

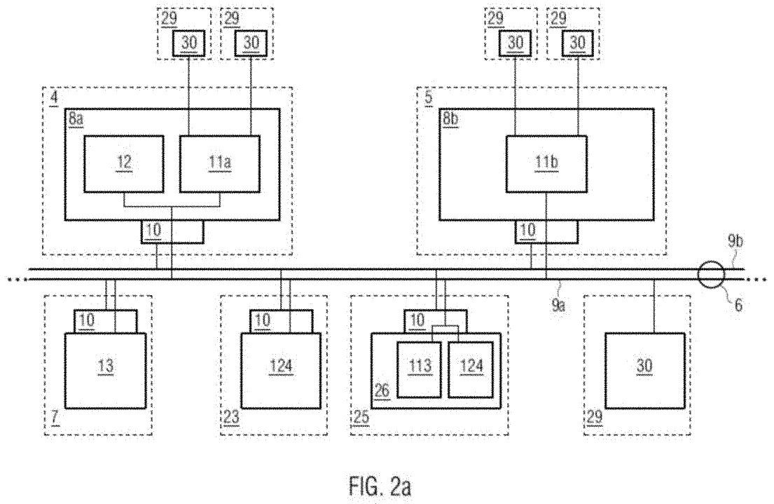

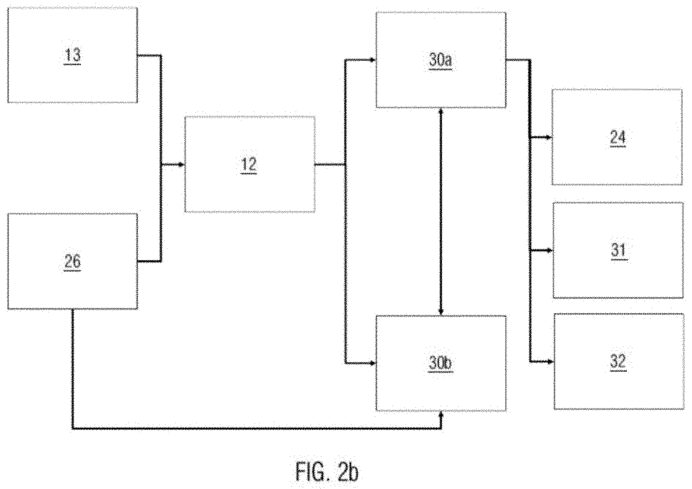

A control program unit 8 is stored on the digital control units 4 and 5 and can be implemented (FIGS. 2a and 2b). The control program unit 8 comprises all computer programs of the respective control unit, which is designed for controlling the components 30 connected with the control units 30 and for communicating with further control units or control program units 8. The control program unit 8 has a data bus interface 10 for communicating with further control program units and a local allocation module 11. The control program unit of the vehicle control unit 8a also includes a central allocation module 12.

The local allocation module 11 serves for controlling the components 29 connected with the respective control unit in line with corresponding activation notifications. The local allocation module 11 is connected with at least one component module 30 of the respective component 29. The central and the local allocation module 12, 11a and 11b are connected with the data busses 9 via the data bus interface 10.

The operating element 7 includes an operating element module 13, which is connected with the data busses 9 via a data bus interface 10. The output element 23 includes an output implementation module 124, which is connected with the data busses 9 via a data bus interface 10. The operator terminal display 25 has an operator terminal display module 26, which is connected with the data busses 9 via a data bus interface 10.

The local allocation module 11 includes an operating element control program component 19, a mapping program component 14, a function program component 15 and a hardware control program component 16. The local allocation module of the attachment 11b also includes an operator terminal display control program component 28. The local allocation module of the attachment 11b also includes web visualisation, later called web visu 20, which generates displayable visualisations, in particular web pages. These visualisations are part of the component description and the interaction description and comprise attachment information, amongst other things. This attachment information for example comprises an image illustration of the attachment 11b, the task status of the attachment 11b, current and/or pre-set parameters of the attachment 11b. A graphic user interface that is transmitted to the operator terminal display 25 is therefore generated. Outputs and inputs can be realised there.

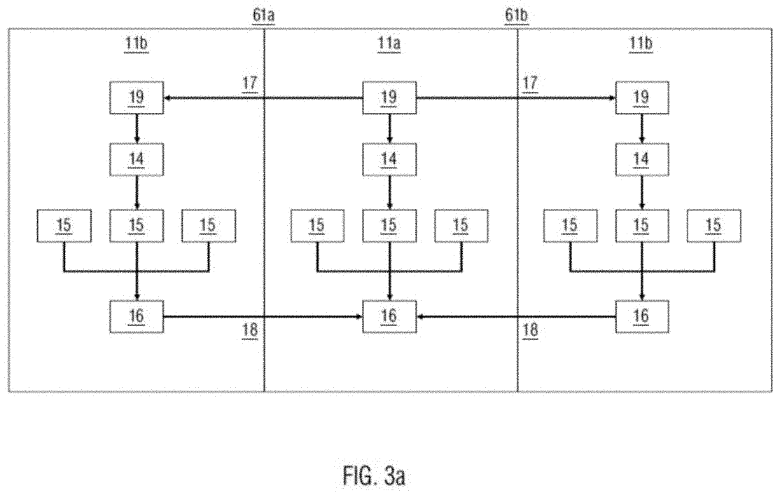

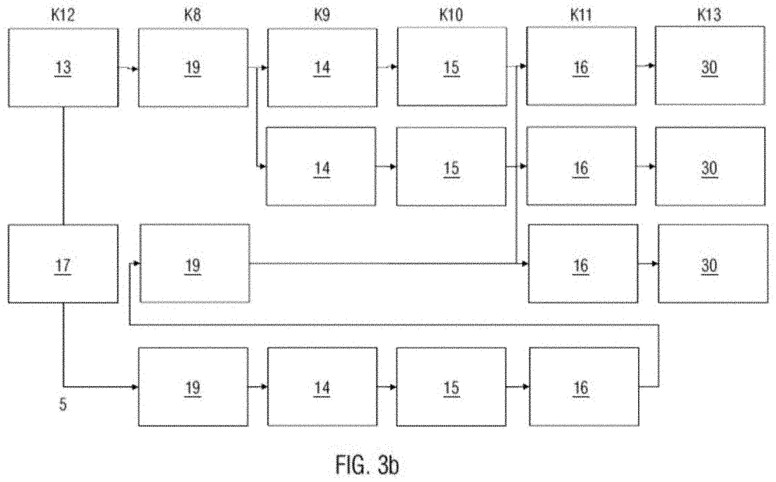

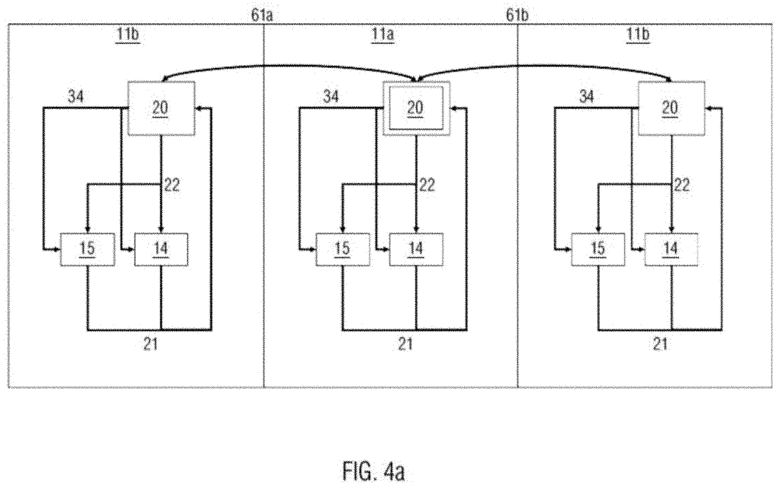

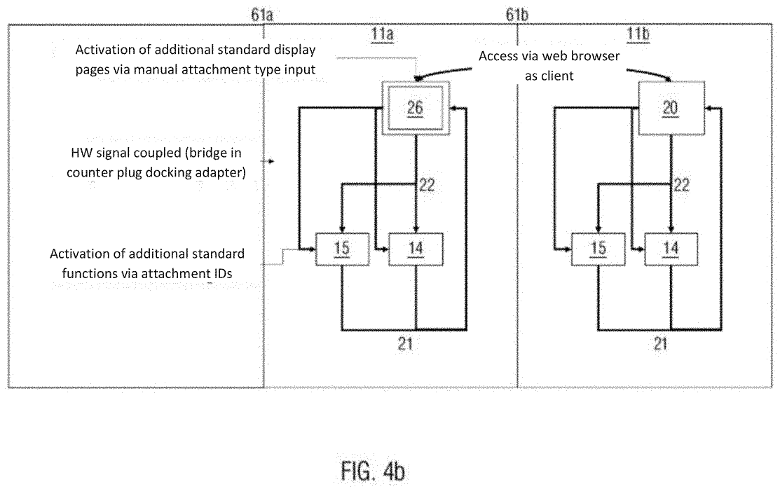

Individual program components within the local allocation module 11 are connected with each other via logic data connections (FIGS. 3-4b). The operating element control program components 19 of individual local allocation modules 11 are connected with each other via the CAN bus 9a. Hardware control program components 16 are also connected from local allocation modules via the CAN bus 91. The web visu 20 of the local allocation modules of the attachments 11b is connected with the operator terminal display control module 28 via the Ethernet 9b.

The software construction of the control system, in particular the local allocation module 11, is divided into several layers (FIG. 3b). An operating element layer IK12, an input layer IK8, an allocation layer IK9, a signal layer IK10, an output layer IK11 and a device control layer IK13. The operating layer IK12 for example includes the operating element module 13, but also a telegram forwarding module IK7, which forwards the telegrams from the operating element module 13 to an attachment control unit 5. Telegrams are forwarded from this layer to the next layer, the input layer IK8. This comprises the operating element control program components 19. This is followed by the allocation layer, which comprises the mapping program component 14. The subsequent layer is the signal layer IK10, which includes the function program components 15. This is followed by the output layer IK11 with the hardware control program component 16. The attachment control unit 5 in turn sends telegrams to an operating element control program component 19. The device layer IK13 follows after the output layer IK11.

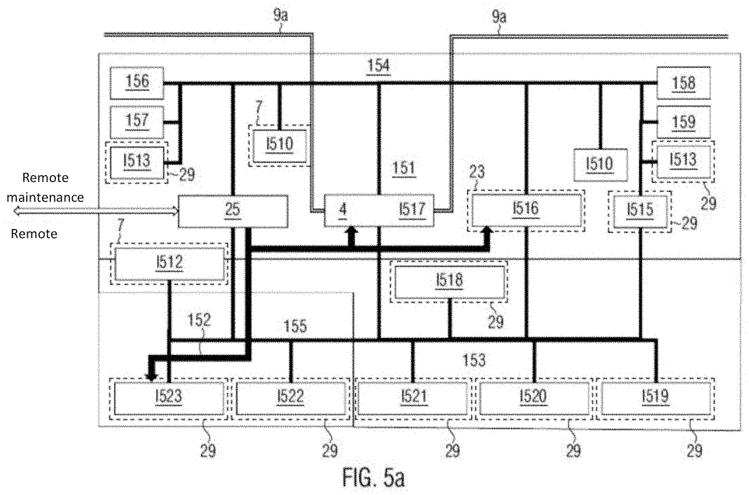

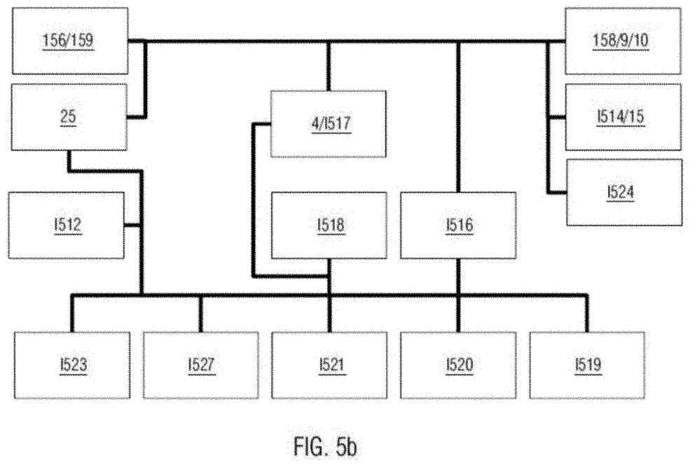

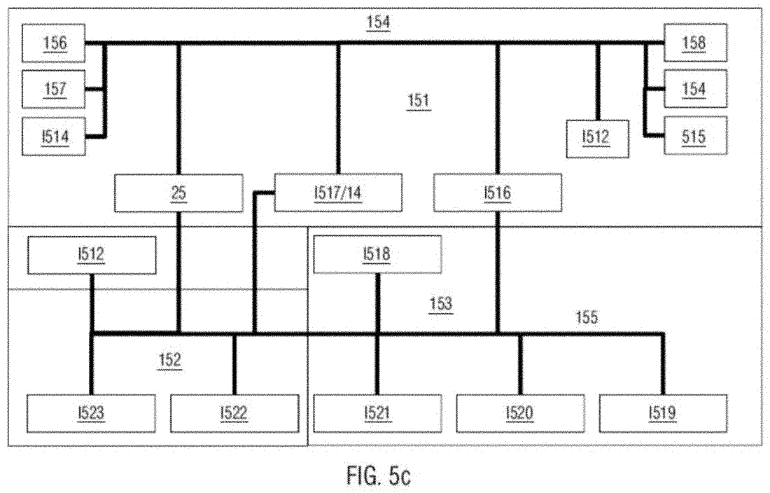

In this embodiment example the internal control structure of the vehicle 1 is divided into three areas (FIG. 5a, 5b, 5c): one main tractor area IS1, one driving area IS2 also called DriCoSoft, and one vehicle data area IS3, also called VDS (English: vehicle data system).

The main tractor area IS1 includes the following operating elements 7:

| | |
|---|---|
| An IO controller 1, such as for example a TTC-30XH ® | IS6 |
| An IO controller 2, such as for example a TTC-30XH ® | IS7 |
| An IO controller 3, such as for example a TTC-30XH ® | IS8 |
| An IO controller 4, such as for example a TTC-30XH ® | IS9 |
| An IO controller 5, such as for example n TTC-30XH ® | IS10 |
| A joystick | IS11a |

The main tractor area IS1 further includes the following components 29:

| | |
|---|---|
| 2 x six CAN prop valves | IS13(a-l) |
| A communication unit, such as | IS15 |
| for example ProEmion 5320 ® | |
| An IO cooling fan controller | IS24 |

The main tractor area IS1 also includes the following:

| | |
|---|---|
| An operator terminal display | 25 |
| A driving operation display as an output element 23, | IS16 |
| for example HY-eVision² 7.0 ® | |
| A chassis control unit as a vehicle control unit 4, | IS17 |
| for example a Bodycontroller TTC-580 ® | |

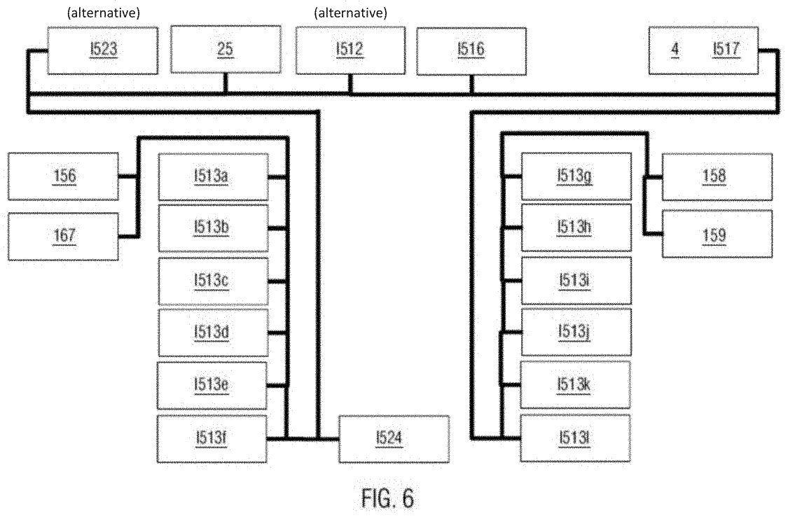

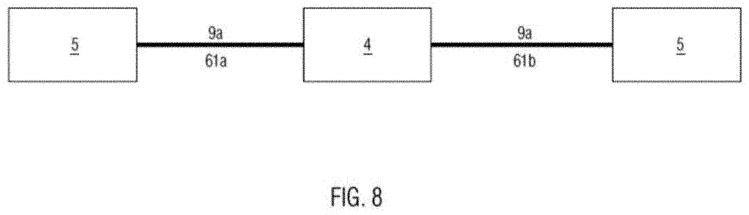

All of these components of the main tractor area IS1 are connected with a vehicle data bus IS4 (FIG. 6), via which these components communicate with each other. Communication preferably takes place via the vehicle data bus with the J1939 protocol. The CAN bus 9a is connected to the chassis control unit IS17 as a vehicle control unit 4, which is in connection with the other control units 5 via connection point 61a at the front and connection point 61b at the back (FIG. 8).

VDS area IS3 includes the following components 29:

| | |
|---|---|
| A gearbox regulator drive regulator, such as | IS18 |
| for example from Bodas ® | |
| Exhaust gas post-treatment, for example from company CAT ® | IS19 |
| An engine control unit, for example from company CAT ® | IS20 |
| A electronic brake regulating system, | IS21 |
| such as for example ABS/ASR | |

In addition the VDS area IS3 includes an operator armrest IS12 as an operating element 7.

The driving area IS2 includes the following components 29:

| | |
|---|---|
| Steering control, such as for example a TTC-32S | IS22 |
| Suspension control, such as for example a TTC-580 | IS23 |

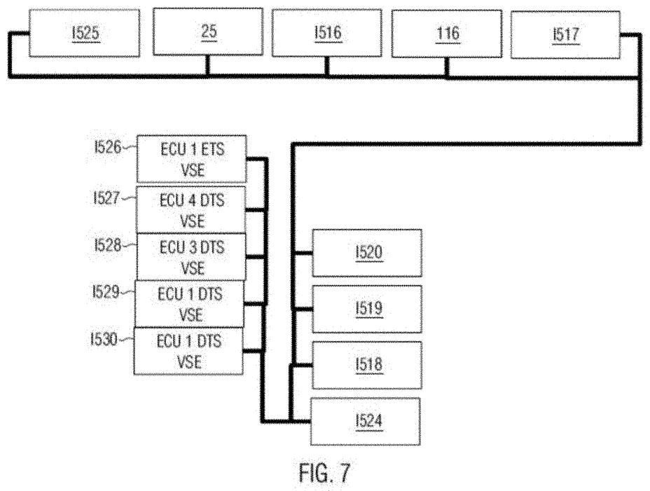

All of these components of the VDS area IS3 and the driving area IS2 are connected with a powertrain data bus IS5, also called powertrain, via which these components communicate with each other. Protocol J1939 is preferably used in the powertrain data bus IS5. The powertrain data bus IS5 is also connected with the operator terminal 25, the chassis control unit IS17, the driving operation display IS16 and the communication unit IS15 of the main tractor area IS1. The powertrain J1939 data bus IS5 is further connected with the following components (FIG. 7):

| | |
|---|---|
| A service interface | IS25 |
| A right joystick | IS11b |
| A control unit (ECU) 1 for a steering system (ETS) | IS26 |
| A control unit (ECU) 4 for a steering system (ETS) | IS27 |
| A control unit (ECU) 3 for a steering system (ETS) | IS28 |
| A control unit (ECU) 2 for a steering system (ETS) | IS29 |
| A control unit (ECU) 1 for a steering system (ETS) | IS30 |

The method of coupling an attachment 2 to the vehicle 1 will be explained below with reference to FIGS. 1 and 2 for the embodiment example. When an attachment 2 is mechanically and electronically connected with the vehicle 1 at the connection point 61 via the data bus 6, all attachment control units 5 are recognised at the data bus 9a/9b as the vehicle control unit 4 regularly sends identification telegrams. Newly recognised attachment control units 5 are then automatically initialised and integrated into the system for data transmission. Other automatic integration methods are feasible. Methods that do not require initialisation are also feasible.

The control program unit 8b of the attachment control unit 5 then notifies the central allocation module 12 about which output elements 23 and operating elements 7 it requires. A component description and an interaction description are sent to the central allocation module 12 for this. The information describes the attachment 2, in particular the components, how to control the same and which operating and output elements are required.

The central allocation module 12 then obtains the rights to the necessary output elements 23 from the local allocation module 11 of the vehicle control unit 4 and operating elements 7 and allocates these to the local allocation module 11 of the attachment control unit. A driver can control this allocation via an operating element 7. The central allocation module 12 sends an allocation notifications, also called allocation telegrams, to all local allocation modules 11 via the CAN bus 9a, in which the allocation of the output elements 23 and the operating elements 7 to the components 29 and the associated local allocation modules 11 is determined. These notifications are stored in such a way that all activation notifications transmitted via the data bus are forwarded by the respective operating element 7 to the allocated component 29 to control these accordingly.

A request can also be sent to the components of the vehicle 1 by the local allocation module of the attachment 11b. These requests include limitations as well as commands. This request can thus for example be the maximum speed of the vehicle 1 or can also tell the vehicle 1 to drive along a pre-determined route.

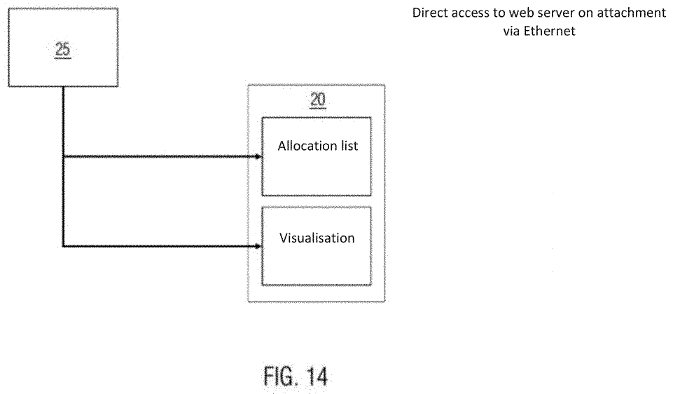

The method for visualising attachment information is explained below for the embodiment example with reference to FIG. 4a. The operator terminal display 25 is designed for illustrating the visualisation of the attachment information. In this embodiment example this is realised via the web browser 33, which is installed on the operator terminal display 25. Individual local allocation modules of the attachments 11b provide information here, which is illustrated on the web browser 33 (FIG. 14). This is generated in the web visu module 20. The operator terminal display 25 can further illustrate information about the own components 29 of the vehicle 1 itself. It therefore also comprises the feature of a web visu 20.

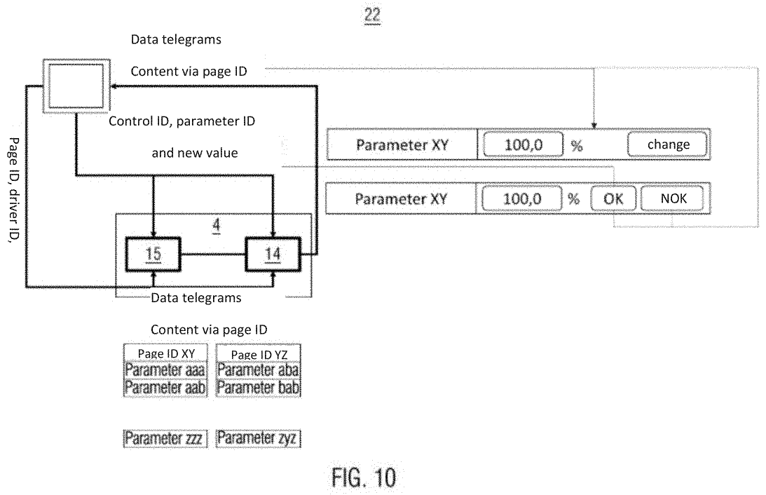

Parameter telegrams 22 are sent from the operator terminal display 25, or from the web visu 20 to the mapping program component 14 and the function program components 15 in the respective local allocation modules 11. At the same time a data request is sent via page IDs 34 from the operator terminal display 25, or from the web visu 20 to the mapping program component 14 and the function program component 15 (FIG. 10). The allocation notifications and the activation notifications can be transmitted in the form of such parameter telegrams 22. Data telegrams therefore in turn send content answers via page IDs 21 from the mapping program component 14 and the function program component 15 in turn back to the operator terminal display 25, or to the web visu 20.

The parameter telegrams 22 include information about the control IDs, parameter IDs and the respective new values. As illustrated in FIG. 10 by way of example for the parameter telegram components 22 in the vehicle 1, parameter XY can for example be set to 100%, wherein this information is then sent to the mapping program component 14 and the function program component 15, which are carried out by the vehicle control unit 4.

The method for controlling an attachment 2 by means of operating elements 7 of the vehicle 1 is explained below with reference to FIG. 3. The operating elements 7 of the vehicle 1 are a central element of vehicle operation. User information of the associated operating elements 7 is read out via operating element control program components 19 and processed in a software technical way. This for example includes digitalisation and incrementation. The user information of the operating element control program components 19 of the local allocation module of the vehicle 11a are sent to the mapping program component 14 of the local allocation module of the vehicle 11a as well as via the operating element telegrams 17, also called activation notifications, via the CAN bus 9a to the operating element control program components 19 of the local allocation modules of the attachments 11b. From there the signals are forwarded to the local mapping program components 14.

After this mapping in the mapping program component 14 the information is prepared in such a way that it can influence certain function program components 15. Corresponding information is then forwarded to the hardware control program component 16 together with other function program components 15, which do not necessarily wait for operating element signals. Component modules 30 can either be controlled directly from there or the information is routed back to the local allocation module of the vehicle 11a and the local hardware control program component 16 via remote telegrams 18, so that component modules 30 are controlled there.

A button can for example be pressed in the vehicle 1. The attachment 2 recognises this button pressure and causes a display to light up in the vehicle 1.

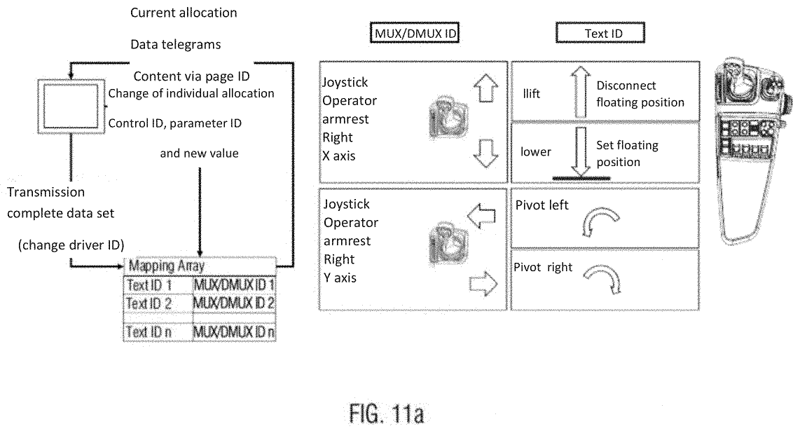

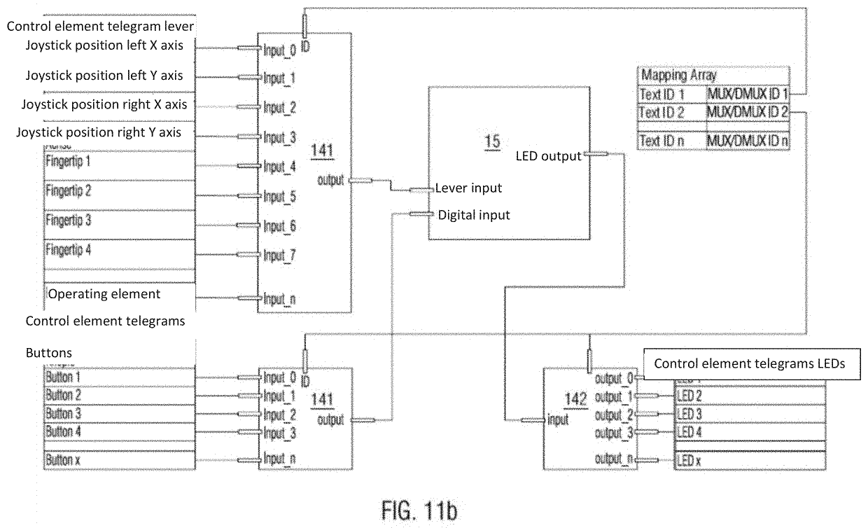

Mapping in the mapping program component 14s is explained below for the embodiment example with reference to FIGS. 11a and 11b. Control element telegrams 35 consisting of a control ID 143, a parameter ID 144 and associated value 145, which transmit the activations and deflections of the operating elements 7, are first bundled in a multiplexer 141 in the mapping program component 14, wherein the value 145 of a corresponding parameter 144 is switched through to the function program component 15. A complete data sets such as for example the change of a driver IDs can also be transmitted depending on the control ID 143. The mapping program component 14 includes different multiplexers 141 for different operating elements 7. A multiplexer is for example provided for the lever and one multiplexer for buttons. After the function program component 15 the signals are transmitted to a de-multiplexer 142. The de-multiplexer 142 is part of the hardware control program component 16, which controls individual component modules 30.

Mapping or allocating further ensures that the operating elements 7 can be used in different ways. A button, but also an element of the touchscreen, can thus have the following features:

Switch when pressed

Switch when released

Switch until released

One-off signal (latch) when pressed

One-off signal (latch) when released

One-off signal (latch) until released (will switch back only when released)

Steering elements such as slides, steering wheels or joysticks can also work in three different ways, which must be taken into consideration in addition to the direction and deflection:
Differential conduct, i.e. a rapid movement ensures greater control than a slow one
Proportional conduct, i.e. control is proportional to the deflection of the steering element
Integral conduct, i.e. control is proportional to the integrated path of the deflection, which ensures that a return to the zero position following positive deflection still effects positive steering.

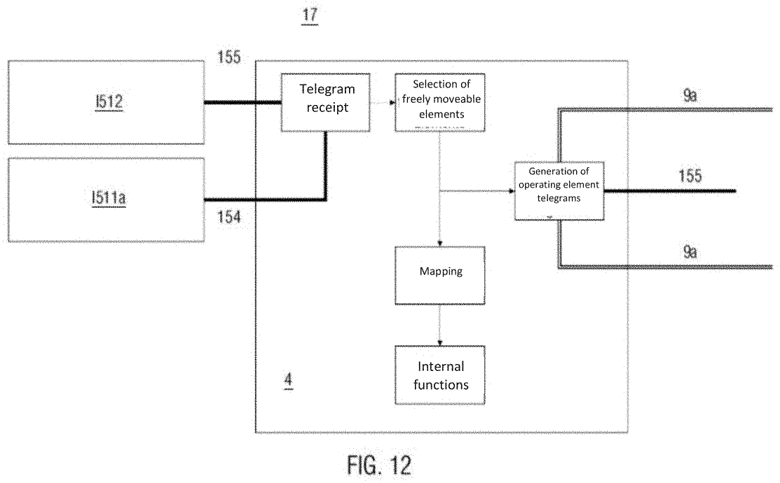

The generation of operating element telegrams n17 by the operator armrest IS23 and the left joystick 11a will be explained below for the embodiment example with reference to FIG. 12. Control signals from the operator armrest IS23 are received in the vehicle control unit 4 by way of telegram receipt via the powertrain data bus IS5 and control signals from the left joystick 11 via the vehicle data bus IS4. A selection of freely moveable elements is then made. From there, notifications for mapping and then for internal functions can be sent, or operating element telegrams are generated, which are then forwarded to the attachment control units via the powertrain data bus IS5 and/or the CAN bus 9a.

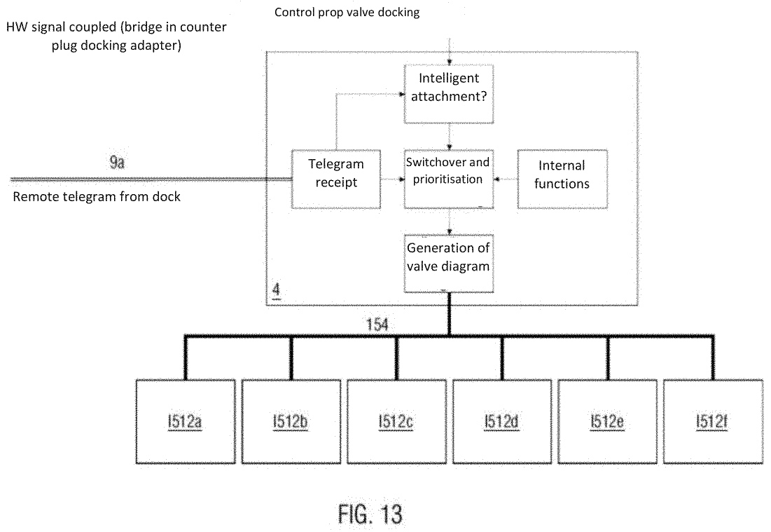

Controlling the prop valves IS12 will be explained below for the embodiment example with reference to FIG. 13. Telegrams are first received in the vehicle control unit 4 from the CAN bus 9a via the data bus interface 10. From there the signal is forwarded for determining switchover and prioritisation. The receipt of telegrams also controls the enquiry of whether it is an intelligent attachment. A HW signal is also coupled for this. The answer of whether it is an intelligent attachment influences switchover and prioritisation as much as it does internal function. Following switchover and prioritisation valve telegrams are created, which are forwarded to individual CAN prop valves IS12 via the vehicle data bus IS4.

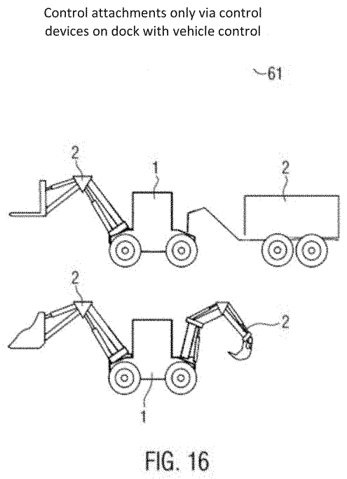

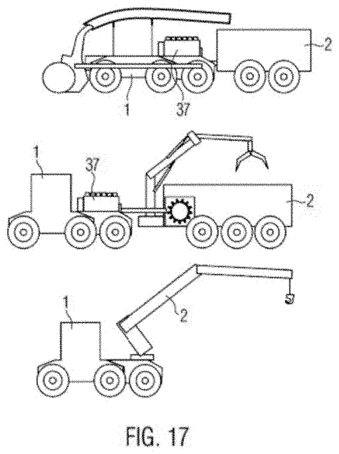

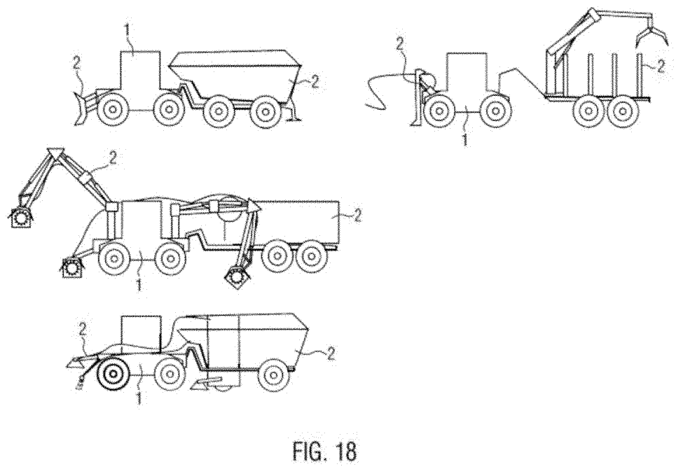

Thanks to the modular construction different combinations of attachments 2 can be connected. Attachments 2 can for example be connected with the vehicle control only via the connection point 61 (FIG. 16). Can also be controlled via a control program unit 8 on the attachment 2 (FIG. 17). It is also possible that the control of attachments 2 is controlled via a control device at the connection point 61 with vehicle control and control of complex attachments via their operating devices, which are connected via additional connections in the vehicle (FIG. 18).

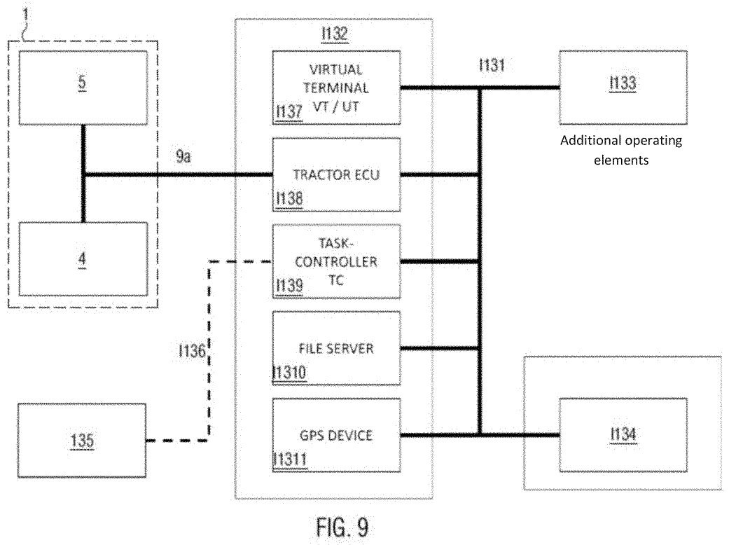

In one embodiment the vehicle 1 can be designed in such a way that it is equipped with an additional engine 37 that can be coupled. This additional engine that can be coupled substantially increases the performance of the vehicle and can also be controlled via the control system. In a further embodiment the operator armrest IS12 and the service interface IS25 can be connected with the vehicle data bus IS4. In a further embodiment the operating elements 7 and the vehicle control unit 4 can communicate with devices with an external data bus such as for example the Isobus® via the CAN bus (J1939) 9a and operate the same (FIG. 9). External systems IB2, such as for example a Kverneland Tellus® system with additional operating elements IB3 and a job controller IB4 on the attachment 2, can communicate via an agricultural engineering data bus IB1, such as the Isobus®. External systems IB2 can include the following components:

| | |
|---|---|
| A virtual terminal | IB7 |
| A tractor control unit (Engl.: tractor ECU) | IB8, |

which is connected with the CAN bus (J1939) 9a

| | |
|---|---|
| Task controller | IB9 |
| File server | IB10 |
| Receiver unit for a global positioning system, | IB11 |
| such as for example GPS | |

The task controller IB9 can be connected with a farm management system IB5 via a data transfer unit IB6 such as for example WLAN, GPRS or a memory stick.

In an alternative embodiment the central allocation module 12 can be part of the control program unit of the attachment 8b. In an alternative embodiment the attachment 1 is without a control program unit 8, which means all information is not automatically provided via the web visu 20 (FIG. 4b). If this is the case additional standard display pages are activated with manual inputs for the attachment type on the operator terminal display 25. A HW signal is also coupled and additional standard functions are activated in the function program component 14 via the attachment IDs.

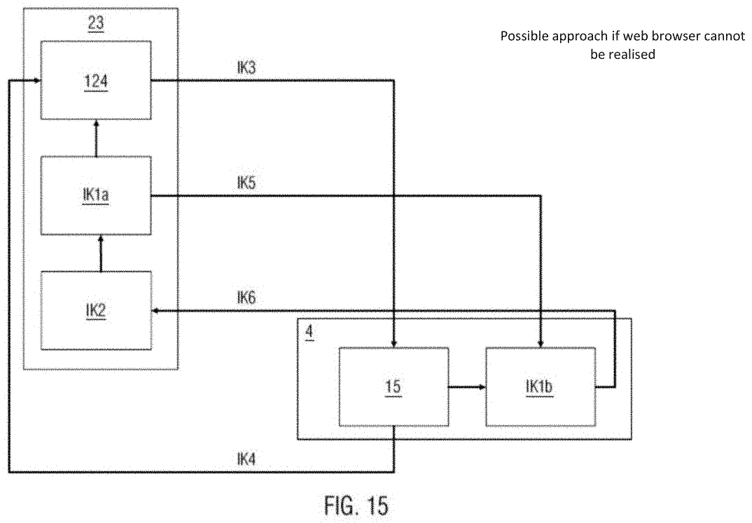

In an alternative embodiment communication between a display, or monitor, as the output element 23 and the attachment control unit 4, can not only run via a web browser (FIG. 15). AN output implementation module 124 is stored at an output element 23, which is here designed as a display in this example, and can be executed. A pre-defined catalogue of graphics and display input fields IK2 is stored in the display. This makes defined images IK1a available to a memory program component, which can then be visualised with the output implementation module 124. The output implementation module 124 sends cyclic telegrams IK3 to the function program component 4 of the vehicle control unit 4, which returns cyclic data telegrams IK4. The function program component 4 further sends defined image information of the attachment IK1b to a memory program component, which includes additional non-cyclic requests IK5 from images of the display IK1a defined by the memory program component. The memory program component IK1b then sends non-cyclic definition telegrams IK6 to the pre-defined catalogue of graphics and display input fields IK2.

### LIST OF REFERENCE NUMBERS

1 Vehicle
2 Attachment
3 Control system
4 Vehicle control unit
41 Processor unit
42 Power supply
43 External interfaces
44 Memory unit
411 Data management unit
412 Data storage unit
413 Data transfer unit
5 Attachment control unit
6 Data bus
61 Connection point
61a Front connection point, front dock
61b Rear connection point, rear dock
7 Operating element
8 Control program unit
8a Control program unit of the vehicle
8b Control program unit of the attachment
9a CAN bus
9b Ethernet
10 Data bus interface
11 Local allocation module
11a Local allocation module of the vehicle
11b Local allocation module of the attachment
12 Central allocation module
13 Operating element module
14 Mapping program component
15 Function program component
16 Hardware control program component
17 Operating element telegram, activating notification
18 Remote telegrams
19 Operating element control program component
20 Web visualisation (web visu)
21 Data telegrams
22 Parameter telegrams
23 Output elements
24 Output program component
25 Operator terminal display
26 Operator terminal display module
28 Operator terminal display control program component
29 Component
30 Component module
30a Component module of the vehicle
30b Component module of the attachment
31 Program component for outputs/valves
32 Program component for control telegrams for sub-systems
33 Web browser
34 Data request via page ID
35 Control element telegrams
36 Functional device
37 Additional engine that can be coupled
124 Output implementation module
141 Multiplexer
142 De-multiplexer
143 Control ID
145 Operating value ID
146 Driver ID
6100 Coupling plate
6101 Base plate
6102 Electronic connection means
6103 Electric connection means
6104 Electric control contact
6113 Hydraulic connection means
6114 Pneumatic connection means
IS1 Main tractor area
IS2 Driving area
IS3 Vehicle data area
IS4 Vehicle data bus
IS5 Powertrain data bus
IS6 IO controller 1
IS7 IO controller 2
IS8 IO controller 3
IS9 IO controller 4
IS10 IO controller 5
IS11a Joystick left
IS11b Joystick right
IS12 Operator armrest
IS13a-1 CAN prop valves
IS15 Communication unit
IS16 Driving operation display
IS17 Chassis control device
IS18 Driving regulator gearbox regulator
IS19 Exhaust gas post-treatment
IS20 Engine control device
IS21 Electronic brake regulator system
IS22 Steering control
IS23 Suspension control
IS24 IO cooling fan controller
IS25 Service interface
IS26 A control unit (ECU) 1 for a steering system (ETS)
IS27 A control unit (ECU) 4 for a steering system (ETS)
IS28 A control unit (ECU) 3 for a steering system (ETS)
IS29 A control unit (ECU) 2 for a steering system (ETS)
IS30 A control unit (ECU) 1 for a steering system (ETS)
IB1 Agricultural engineering data bus
IB2 External system
IB3 Additional operating elements
IB4 Job controller
IB5 Farm management system
IB6 Data transfer unit
IB7 Virtual terminal
IB8 Tractor control unit
IB9 Task controller
IB10 File server
IB11 Receiver unit for a global positioning system
IK1a Memory program component, defined images of the output element
IK1b Memory program component, defined images of the attachment
IK3 Cyclic telegram
IK4 Cyclic data telegram
IK5 Non-cyclic request
IK6 Non-cyclic definition telegram
IK7 Telegram forwarding
IK8 Input layer
IK9 Allocation layer
IK10 Signal layer
IK11 Output layer
IK12 Operating element layer
IK13 Device layer

1. A digital control unit with a central processor unit for controlling at least one component of a vehicle or an attachment and with a control program unit,
which is stored only on the control unit and can be implemented there,
and an interface to a data bus,
wherein several operating elements can be coupled to the control unit and one or more further control units by means of the data bus,
wherein the operating elements generate an activation notification upon activation and transmit this via the data bus,
wherein the activation notification includes at least information about the type of activation and about the operating element,
wherein the control program unit includes a local allocation module,
which reads the activation notifications for a specific component,
which is coupled to the digital vehicle control unit,
from the data bus and forwards corresponding control signals to this component,
and the control program unit includes a second allocation module,
which generates an allocation notification upon a new allocation of an operating element to a component and sends this to the local allocation module of this or another control unit, and to the respective local allocation module via the data bus,
so that this stores this allocation of the operating element on the component in such a way that all activation notifications transmitted via the data bus are forwarded from the respective operating element to this component,
for controlling the same accordingly.

2. A control system for a combination of a vehicle and at least one attachment coupled with the vehicle, wherein the control system comprises the following:
a digital vehicle control unit with a central processor unit for controlling at least one component of the vehicle,
a digital attachment control unit with a central processor unit for controlling at least one component of the attachment,
a disconnectable data connection between the vehicle control unit and the attachment control unit,
wherein the disconnectable data connection comprises a data bus,
operating elements,
which are connected with the vehicle control unit as well as with the attachment control unit via the data connection,
wherein an activation notification is generated upon activating the respective operating element and transmitted via the data bus,
which includes at least information about the type of activation and about the operating element,
wherein each control unit has a control program unit,
which is stored only on the respective control unit and can be implemented there,
and the control program units each have an interface for communicating via the data bus,
so that all control program units can exchange data amongst themselves.

3. The control system of claim 2, wherein the digital vehicle control unit and/or at least one of the digital attachment control units is designed according to claim 1.

4. The control system of claim 2, wherein each control program unit includes an output program component for issuing information that reflects the status of the control program unit or of components coupled to the same, wherein the output program component generates control commands with which this information is issued directly to an output element.

5. The control system of claim 2, wherein each control program unit a local allocation module for arranging an operating element to a component of the vehicle or the attachment on which this control program unit is located,
and the vehicle control unit or an attachment control unit includes a central allocation module,
which includes a user interface,
to which a user can allocate an operating element of a component,
wherein the central allocation module generates a notification to the local allocation module, the control program unit, upon further allocation,
which is linked with the respective component,
wherein the local allocation module stores this allocation of the operating element on the component in such a way
that all activation notifications transmitted via the data bus are forwarded from the respective operating element to this component,
for controlling the same accordingly.

6. The control system of claim 2, wherein the vehicle includes a coupling for coupling attachments, which includes a drive shaft and/or a plug-in connection for an electric line and/or a plug-in connection for a hydraulic line and/or a plug-in connection for a pneumatic line, wherein the control program units of the vehicle and the attachments are designed in such a way that they influence the operation of the vehicle coupled with the same and/or the attachment only through instructions, requests and commands, with which mechanical, electrical, hydraulic or pneumatic performance at the coupling is defined.

7. The control system of claim 2, wherein the central allocation module generates a notification to the local allocation module upon a new allocation of an operating element and sends it to the same, the component of which was allocated to the operating element until now, in order to cancel this allocation.

8. The control system of claim 2, wherein the control program unit of this attachment sends a notification to the central allocation module after coupling an attachment to a vehicle, in which at least the components of the attachment are defined, so that the central allocation module registers this component.

9. The control system of claim 2, wherein the operating elements are designed in such a way that only two classes of activation notification exist, wherein one class includes a logical value (true or false) and other class a number value that specifies the degree of activation.

10. The control system of claim 9, wherein the operating elements, which generate the activation notifications with a logical value, are designed in such a way that different types of activation notifications exist, wherein one type each
switches when pressed,
switches when it is released,
switches until it is released,
switches a one-off signal (latch) when pressed,
switches a one-off signal (latch) when it is released, or
switches a one-off signal (latch) until it is released.

11. The control system of claim 2, wherein the control system includes at least one plug-in connection with an electric interface for the disconnectable coupling of an operating element, wherein the control program unit includes one or more operating interface modules for being able to communicate an operating element each that can be coupled to the same.

12. The control system of claim 2, wherein the control system includes several central allocation modules, wherein the central allocation modules are designed in such a way that they are synchronised.

13. The control system of claim 2, wherein the control system is constructed in layers, wherein the control system in particular has an input layer, a function layer and an output layer.

14. The control system of claim 13, wherein the function layer is divided into an allocation layer and a signal layer.

15. An adapter for an attachment for a control system according to claim 2, wherein the adapter can be coupled to a data bus and comprises a local allocation module for the attachment.

16. A functional device, with for example a vehicle or an attachment, comprising a digital control unit according to claim 1.
